(19) United States
(12) Patent Application Publication
(10) Pub. No.: US 2018/0154231 A1
(43) Pub. Date: Jun. 7, 2018

(54) GOLF PUTTER GRIP

(71) Applicant: Bernerd Garsen, Miami, FL (US)

(72) Inventor: Bernerd Garsen, Miami, FL (US)

(21) Appl. No.: 15/691,314

(22) Filed: Aug. 30, 2017

Related U.S. Application Data
(60) Provisional application No. 62/381,291, filed on Aug. 30, 2016.

(51) Int. Cl. A63B 60/10; G09B 19/00; A63B 60/14

(52) U.S. Cl. CPC A63B 60/10; A63B 53/007; A63B 60/14; G09B 19/0038

(57) ABSTRACT

Disclosed is a golf putter grip having proximal and distal ends, the distal end being open and the proximal end being closed, and including a bore therethrough for installation of a golf putter. The putter grip of the present invention further comprises a main grip area having a left surface, a right surface, a forward facing surface, and a rear facing surface arranged in a trapezoidal shape resulting in two vertex lines running longitudinally along the front of the main grip area, and two vertex lines running longitudinally along the rear of the main grip area. The rear facing surface of the main grip area is parallel to the forward facing surface of the main grip area.

### CLAIM OF PRIORITY

This application is being filed as a non-provisional patent application under 35 U.S.C. § 111(b) and 37 CFR § 1.53(c). This application claims priority under 35 U.S.C. § 111(e) to U.S. provisional patent application Ser. No. 62/381,291 filed on Aug. 30, 2016, the contents of which are incorporated herein by reference.

### FIELD OF INVENTION

The present invention relates to equipment used to play the sport of golf. More particularly, the present invention relates to a hand grip (“grip”) for a golf putting club (“putter”) which forces the player to place his hands in a position which is conducive to greater balance and control of the club.

### BACKGROUND OF THE INVENTION

Unlike many other facets of the game of golf which rely on power, and strength, putting relies, for the most part, on finesse. Specifically, a solid, smooth and balanced putting stroke is essential to achieve good results within the greens. For this reason, many golf experts believe that putting is the hardest aspect of the game of golf to master.

Successful putting requires a chain of events to occur in a specific order starting with the body and ending with the putter face striking the ball. The interface between body and putter occurs at the grip which is significant because this is the point where the “chain” can be broken due to a poor interaction which disrupts the body's muscular recruitment sequence for an efficient putting stroke.

Traditional putter grips are designed without a clear understanding of how hand position affect's the body's natural ability to perform a smooth, efficient and repeatable putting stroke. This fact is evident as seen by the increasing popularity of “fat” putter grips, belly and long putters which try to tap into the body's efficient muscular recruitment pattern.

Golfers at all levels are always looking to maximize optimal club and body interaction in order to make them perform as one. When this occurs, the movement sequence produces a smooth and accurate stroke more often.

Previous attempts at putter grips that optimize the interaction between the golfer and the club have failed to achieve good results.

Accordingly, it is an object of the present invention to provide a golf putter grip that creates a desirable interaction between body and putter that automatically turns on the correct upper body muscular recruitment sequence resulting in an efficient putting movement.

It is a further object of the present invention to provide a golf putter grip that automatically places the golfer's hands in a position so that their palms face each other and the wrists are in a neutral position.

It is a further object of the present invention to provide a golf putter grip that teaches and encourages a repeatable and correct putter stroke

These and other objects, features, and advantages of the present invention may be more clearly understood and appreciated from a review of ensuing detailed description of the preferred and alternate implementations and by reference to the accompanying drawings and claims.

### SUMMARY OF THE INVENTION

The following summary is provided to introduce a selection of concepts in a simplified form that are further described below in the detailed description. This summary is not intended to identify key features or essential features of the claimed subject matter, nor is it intended to be used to limit the scope of the claimed subject matter.

The present disclosure is directed to a golf putter grip that is designed to improve the golfer's putter stroke through improved posture and arm positioning.

According to one implementation of the present invention, provided is a golf putter grip having proximal and distal ends, the distal end being open and the proximal end being closed and including a bore therethrough for installation of a golf putter. The putter grip of the present invention further comprises a main grip area having a forward facing surface, a left surface, a right surface, and a rear facing surface. The left surface, right surface, forward facing surface and rear facing surface may be arranged in a trapezoidal shape resulting in two vertex lines running longitudinally along the front of the main grip area, and two vertex lines running longitudinally along the rear of the main grip area. The left surface, right surface, forward facing surface and rear facing surface form a substantially trapezoidal cross section with two vertices formed in the forward facing direction, and two vertices formed in the rear facing direction. The entire length of the main grip area of the grip may taper gradually in the proximal-to-distal direction. Alternatively, the entire length of the main grip area may remain untapered in the proximal-to-distal direction.

These and other features and advantages will be apparent from a reading of the following detailed description, and a review of the appended drawings. It is to be understood that the foregoing summary, the following detailed descriptions, and the appended drawings are only explanatory and are not restrictive of various aspects claimed.

### BRIEF DESCRIPTION OF THE DRAWINGS

FIG. 1.1 is an isometric view of a golf putter grip in accordance with an implementation of the present invention.

FIG. 1.2 is a rear elevation view of a golf putter grip in accordance with an implementation of the present invention.

FIG. 1.3 is a front elevation view of a golf putter grip in accordance with an implementation of the present invention.

FIG. 1.4 is a left elevation perspective view of a golf putter grip in accordance with an implementation of the present invention.

FIG. 1.5 is a right elevation perspective view of a golf putter grip in accordance with an implementation of the present invention.

FIG. 1.6 is a top elevation view of a golf putter grip in accordance with an implementation of the present invention.

FIG. 1.7 is a bottom elevation view of a golf putter grip in accordance with a first implementation of the present invention.

FIG. 2.1 is an isometric view of an untapered golf putter grip in accordance with an implementation of the present invention.

FIG. 2.2 is a rear elevation view of an untapered golf putter grip in accordance with an implementation of the present invention.

FIG. 2.3 is a front elevation view of an untapered golf putter grip in accordance with an implementation of the present invention.

FIG. 2.4 is a left elevation perspective view of an untapered golf putter grip in accordance with an implementation of the present invention.

FIG. 2.5 is a right elevation perspective view of an untapered golf putter grip in accordance with an implementation of the present invention.

FIG. 2.6 is a top elevation view of an untapered golf putter grip in accordance with an implementation of the present invention.

FIG. 2.7 is a bottom elevation view of an untapered golf putter grip in accordance with a first implementation of the present invention.

### DETAILED DESCRIPTION OF THE INVENTION

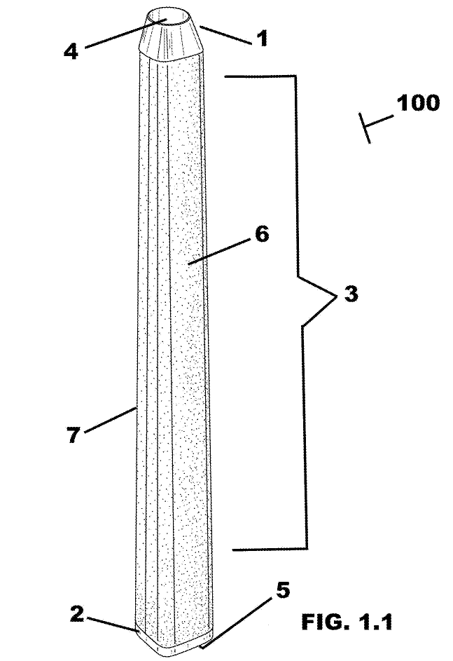

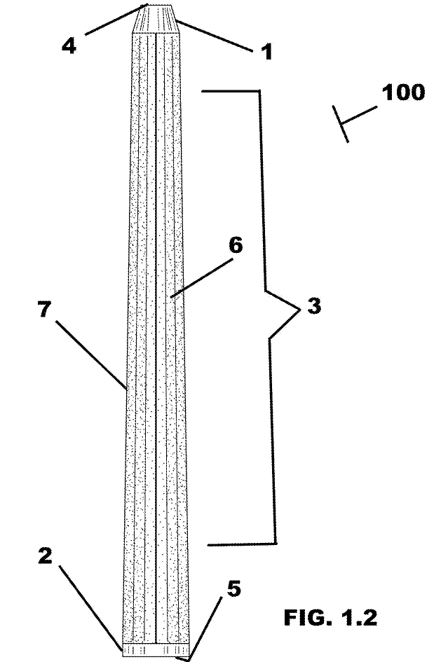

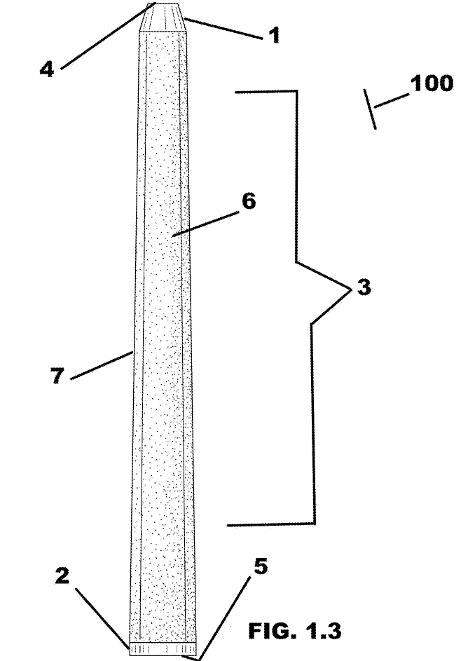

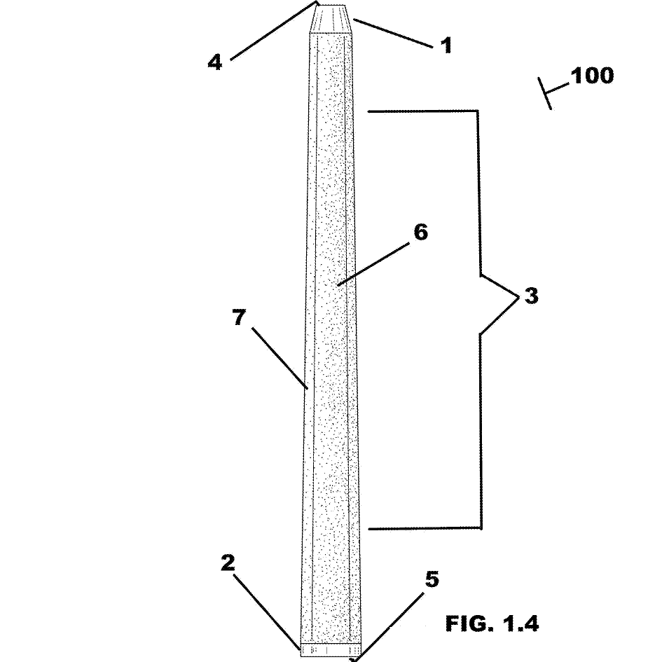

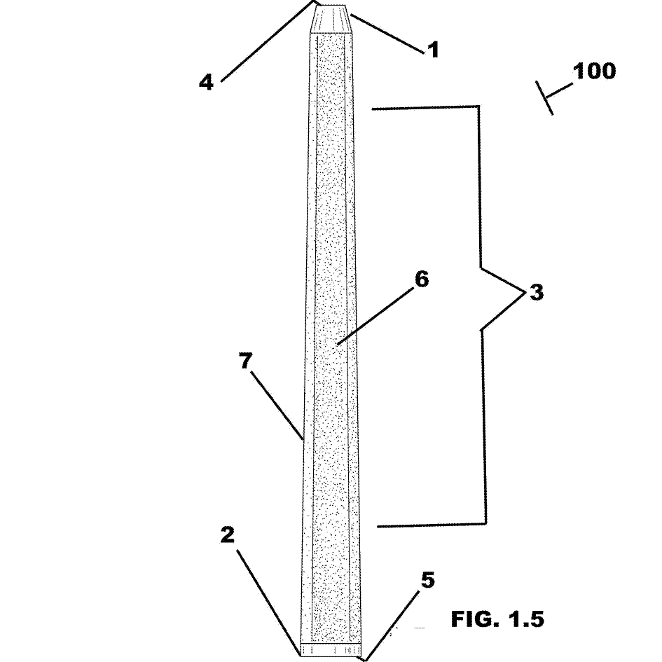

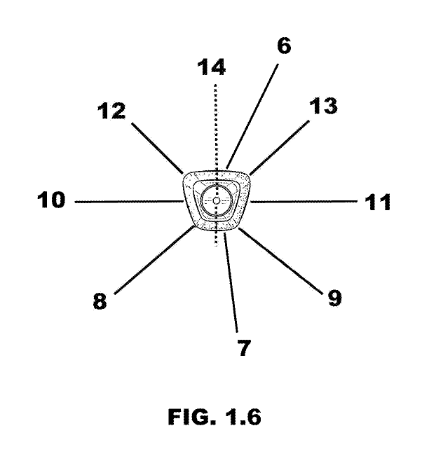

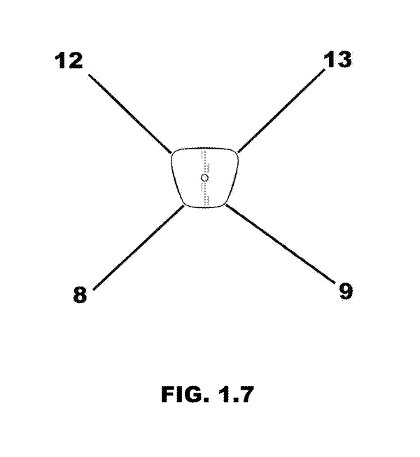

Referring to FIGS. 1.1-1.5, in an example implementation of the present invention, a putter grip 100 is provided having a distal end 1, a proximal end 2, a main grip area 3, a bore opening 4 on the distal end 1, and a closed surface 5 on the proximal end 2.

The bore opening 4 may be utilized for insertion of a putter shaft (not shown). The bore opening 4 extends substantially from the distal end 1 to the proximal end 2, where it is ultimately capped by a closed surface 5. The bore opening 4 is more clearly illustrated in FIG. 1.6 where it is shown having a circular shape. However, the bore opening 4 may be any shape that substantially matches the cross section of an upper shaft of a putter where the putter grip is to be installed. The closed surface 5 is more clearly illustrated in FIG. 1.7 where it is shown having a generally trapezoid or trapezoidal shape. However, the closed surface 5 can have any shape that is aesthetically pleasing to the golfer.

The main grip area 3 may have a forward facing surface 6, a left surface 10, a right surface 11 and a rear facing surface 7 located between the proximal end 2 and the distal end 1 of the grip 100. The forward facing surface 6, left surface 10, right surface 11 and rear facing surface 7 are all generally planar in shape. The forward facing surface 6 and the rear facing surface 7 are substantially parallel to one another throughout the entire length of the main grip area 3. The rear facing surface 7 has a width shorter than the width of the forward facing surface 6, wherein the rear facing surface 7 having the shorter width is closest to a golfer's body. The left surface 10 and the right surface 11 may have a substantially similar width. In another implementation, the rear facing surface may have a seam that extends longitudinally from the proximal end to the distal end of the rear facing surface.

The disposition and shapes of the forward facing surface 6 and the rear facing surface 7 is more clearly shown in FIG. 1.6, which represents an upward-looking cross sectional view of the putter grip 100. The cross sectional view is taken approximately midway down the main grip area 3, but has substantially proportional cross sections taken along the entire length of the main grip area 3.

As can be seen in FIG. 1.6, the forward facing surface 6 and the left surface 10 intersect at lateral vertex line 12. The forward facing surface 6 and the right surface 11 intersect at lateral vertex line 13. The rear facing surface 6 and the left surface 10 intersect at lateral vertex line 8. The rear facing surface 6 and the right surface 11 intersect at lateral vertex line 9. In a preferred implementation, the left surface 10 and right surface 11 converge towards the rear facing surface 7. The left surface 10, right surface 11, forward facing surface 6, and rear facing surface 7 are arranged in a trapezoidal shape resulting in two vertex lines (12, 13) running longitudinally along the front of the main grip area 3, and two vertex (8, 9) lines running longitudinally along the rear of the main grip area 3.

The left surface 10, right surface 11, forward facing surface 6, and rear facing surface 7 form a substantially trapezoidal cross section with two vertices (12, 13) formed in the forward facing direction, and two vertices (8, 9) formed in the rear facing direction. The left surface 10 and right surface 11 converge toward the rear facing surface 7 at vertex lines 8 and 9, respectively. The vertices may form a line common to two surfaces that extends the entire length of the main grip area 3. Alternatively, the vertices may form a curved shoulder common to two surfaces that extends the entire length of the main grip area 3.

It should be noted that when properly installed, forward vertex lines (12, 13) are aligned with the shaft of the putter so that an imaginary line 14 bisecting the grip from rear to front (see FIG. 1.6) is parallel to the face of the putter.

As can best be seen in FIGS. 1.1-1.5, the entire putter grip 100 may taper substantially uniformly from the proximal end 1 to the distal end 2.

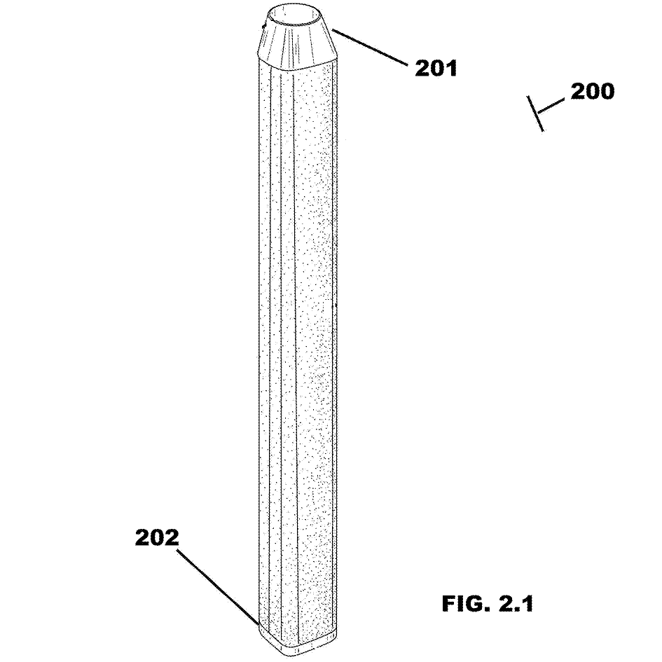

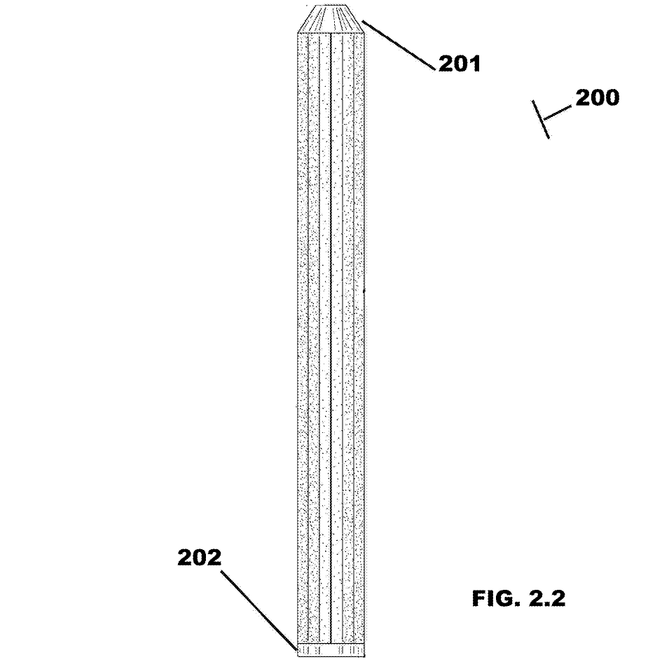

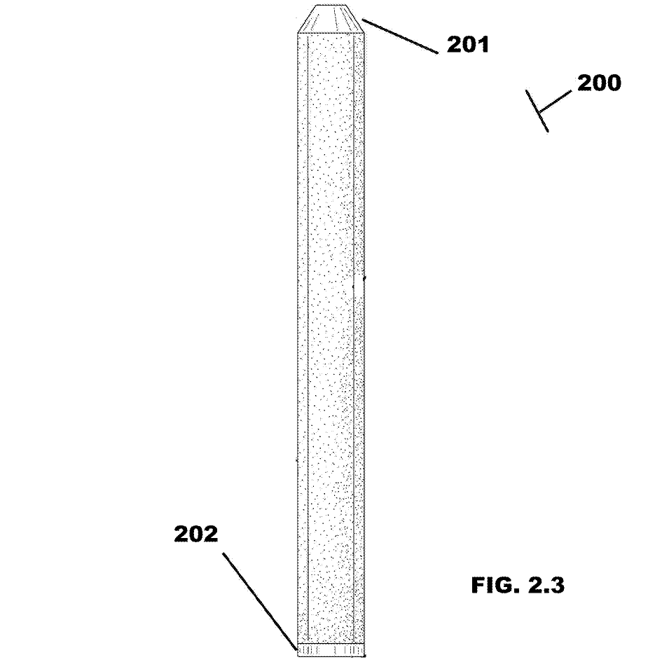

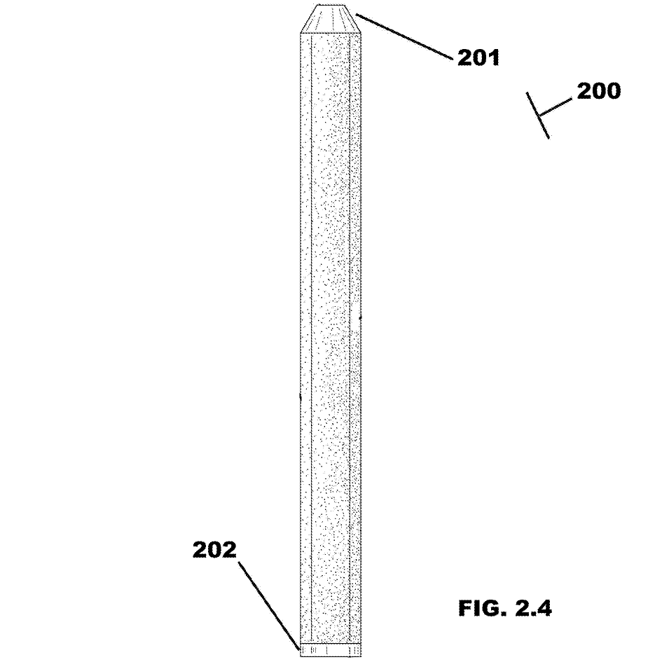

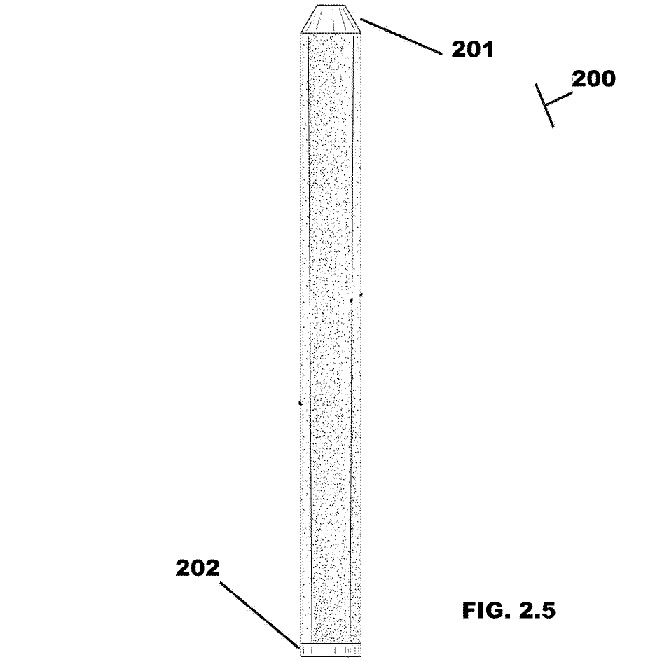

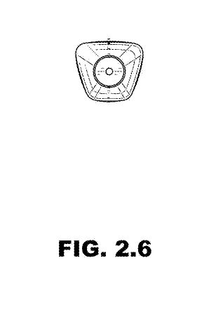

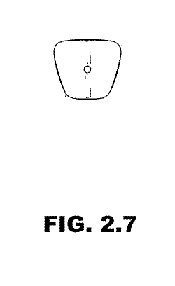

Additional implementations of the present invention are shown in FIGS. 2.1-2.5. The implementations shown in these figures are substantially identical to the previously described implementation, except that the entire putter grip 200 remains untapered uniformly from the proximal end 201 to the distal end 202.

In use, the putter grip of the present invention creates a desirable interaction between body and putter that automatically turns on the correct upper body muscular recruitment sequence resulting in an efficient putting movement. This is accomplished by placing the hands in a position so the palms face each other and the wrists are neutral. This small change to hand and wrist position on the grip makes a fundamental change to muscular recruitment and interaction between body and putter.

When a golfer holds the putter grip, the left surface 10 and the right surface 11 of the main grip area 3 direct the golfer's palms to face each other and place the wrists in a neutral position. With the palms facing each other and wrists neutral, the new position naturally places the arms next to the body without arm or shoulder tension. With the arms in this position, the body will recruit larger muscles of the trunk needed for torso and shoulder rotation instead of recruiting forearm or arm muscles which cause hand, wrist or elbow involvement during the stroke. Specifically, the external and internal oblique muscles (located in anterior lower/mid trunk) in conjunction with the lower trapezius muscles (located in posterior upper trunk) generate a fluid rotation of the torso and shoulders with simultaneous smooth putter movement.

Any reference in this specification to “one implementation,” “an implementation,” “example implementation,” etc., means that a particular feature, structure, or characteristic described in connection with the implementation is included in at least one implementation of the invention. The appearances of such phrases in various places in the specification are not necessarily all referring to the same implementation. In addition, any elements or limitations of any invention or implementation thereof disclosed herein can be combined with any and/or all other elements or limitations (individually or in any combination) or any other invention or implementation thereof disclosed herein, and all such combinations are contemplated with the scope of the invention without limitation hereto.

It should be understood that the examples and implementations described herein are for illustrative purposes only and that various modifications or changes in light thereof will be suggested to persons skilled in the art and are to be included within the spirit and purview of this application.

I claim:

1. A golf putter grip comprising:
a proximal end and a distal end, the distal end being open and the proximal end being closed, and including a bore therethrough adapted to fit on the shaft of a putter;
a main grip area located between the proximal end and the distal end having a forward facing surface, a left surface, a right surface, and a rear facing surface;
the left surface, right surface, forward facing surface, and rear facing surface arranged in a trapezoidal shape resulting in two vertex lines running longitudinally along the front of the main grip area, and two vertex lines running longitudinally along the rear of the main grip area;
the rear facing surface of the main grip area being parallel to the forward facing surface of the main grip area; and
the width of the forward facing surface being shorter than the width of the rear facing surface.

2. The golf putter grip of claim 1, wherein in the main grip area tapers gradually along its longitude in the proximal-to-distal direction.
